(19) United States
(12) Patent Application Publication
(10) Pub. No.: US 2004/0024711 A1
(43) Pub. Date: Feb. 5, 2004

(54) Method of and system for filing orders

(76) Inventors: Walt Camping, Phoenix, AZ (US); John Rhodes, Phoenix, AZ (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/209,669

(22) Filed: Aug. 1, 2002

(51) Int. Cl. G06F 17/60

(52) U.S. Cl. 705/64

(57) ABSTRACT

Automotive vehicles and trailer mounted boats are repossessed with a system including a central station with a computer arrangement which prepares a first message including order information from lien holders. The first message is sent by e-mail to tow trucks via a communication link including the Internet and a wireless link. The tow trucks include a computer for receiving the first messages. The tow truck drivers prepare second e-mail messages which are sent back to the computer arrangement via a wireless link and the Internet. The lien holders can access the computer arrangement to determine order status.

### FIELD OF INVENTION

The present invention relates generally to methods of and systems for filling orders a supplier receives from a plurality of customers and more particularly to such a method and system using a computer arrangement for supplying first messages with information about the orders to field units and responsive to second messages from the field units indicative of whether the field units filled the orders. In a particular embodiment, the supplier supplies repossession services to its lien holder customers and the orders concern articles of personal property to be repossessed.

### BACKGROUND ART

Despite advances in technology, a considerable amount of paper work is required to fill orders which involve objects and are filled with mobile field units, that is, cars and/or trucks, driven by associates of the establishment taking the orders. Customers usually communicate their orders to the establishment orally by telephone, or in writing by facsimile or letter, that is, by mail. An operator of the establishment usually manually prepares a paper order form in response to the oral or written communication. The manually prepared order form is delivered, usually with manual steps, to personnel who fill the order and manually check off objects in the paper order form as the order is being filled. The filled order and paper order form are passed on, frequently through the hands of other personnel of the establishment, to the associate who drives the car or truck and fills a number of orders during a particular run. Before the run can be made, an associate employee, e.g., of the establishment manually prepares, on a paper form, a list including the names and addresses of customers whose orders are to be filled during the run, and information about the order, such as the order number and/or the object associated with the order. The associate, upon filling the order, manually marks the list indicating that the order has or has not been successfully filled and in certain instances manually marks the list to indicate other information, such as the amount of money collected and/or the time of the order being filled. Upon completion of the run, the associate manually handles the paper form including the list to assure that the list goes to other personnel of the establishment for further processing, such as posting that the order has been filled, indicating the amount of money collected, the time of the order being filled and advising the customer that the order has been filled. The numerous manual operations on paper format are costly because of the time required to perform them and are subject to numerous instances of errors.

The problem is particularly acute in cases where the establishment taking the orders is a repossession agency having a main station and several satellite stations in disparate locations from each other and the main station. In such a case, (1) the customers are lien holders who communicate with the station of the repossession agency closest to them, (2) the objects are personal property articles, particularly automotive vehicles or trailer mounted boats, (3) the associates are tow truck drivers, and (4) the mobile field units are tow trucks dispatched by the same station which received the order. The lien holders notify the agency usually by facsimile communication, such that the different lien holders have order forms in different formats.

An employee of the agency responds to the different order forms and to orders in other formats, for example, as received orally by telephone, to manually prepare an agency paper order form, referred to as a repossession program. All the repossession programs have a single format. A manager at the station receiving the order reviews the manually prepared paper repossession program and, if necessary, investigates the order and then assigns an associate with the responsibility of repossessing the article associated with the order. The manager then gives the associate a copy of the paper repossession program, together with several other paper repossession programs, so that if the associate is unsuccessful in carrying out the repossession assignment associated with one paper repossession program, the associate has other assignments.

The associate then begins the repossession process, during which he orally makes a record of his activities in a tape recorder cassette. Upon completion of the run, the associate manually transfers the cassette to a data clerk of the agency who transcribes the record on the cassette and transfers the information in the record to the paper repossession program, whereby the repossession program is updated with the current status of the order. The data clerk then prints all updates of the repossession program and sends the printed version of the updates to the lien holder which ordered repossession of the vehicle associated with the repossession program, as well as to the manager of the station which received the order.

If the associate is unsuccessful in repossessing the vehicle, the copy of the paper repossession program is assigned back to that associate or to another associate working out of the station which received the assignment. If the vehicle (i.e. car, truck, trailer or trailer mounted boat) is not successfully repossessed after several attempts, the manager of the station receiving the order reviews the copy of the paper repossession program and contacts the lien holder for further instructions, in an attempt to develop further information about the vehicle, particularly the whereabouts of the vehicle. The further information about the vehicle is manually entered, by keyboarding, on a modified repossession program which is then printed for processing as described above. If the attempts to repossess the vehicle remained unsuccessful, the order is closed and the station which took the order creates an invoice which is mailed to the lien holder.

If the associate is successful in repossessing the vehicle, the associate tows the vehicle to an impoundment lot of the station of the agency which received the order. The associate gives his copy of the paper repossession program associated with the vehicle to a manager of the lot who forwards it to personnel in the data processing office at the station which received the order. These personnel close the repossession program associated with the vehicle. The data processing office personnel prepare a paper report and create an invoice, both of which are forwarded, typically by mail, facsimile transmission or hand carry, to the customer. Many manual steps are involved in creating and forwarding the invoice.

The agency is frequently responsible for being sure that the vehicle is sold to a third party, usually by auction. Based on the information in the repossession program, the data processing office personnel manually prepare a paper personal property report and a paper auction delivery form. Personnel on the impoundment lot prepare a paper vehicle condition report, all of which are reviewed by the manager of the station where the order was placed. After the station manager completes his review, the paper reports are given to the lot manager who, if necessary, has keys made for the vehicle. The lot manager also sends copies of the condition and personal property reports to the lien holder, usually by facsimile, and forwards these reports to a filing office at the central station of the repossession agency which received the order. The lot manager gives the paper auction delivery form to a driver of a vehicle transport truck who is responsible for delivering the repossessed vehicles to auction. A representative of the auctioneer signs the auction delivery form for each vehicle the auctioneer receives and returns, usually by regular mail, the signed auctioneer delivery form to the repossession agency station which sent the vehicle to the auctioneer. A data clerk in the repossession agency station which sent the vehicle to the auctioneer responds to the returned, signed auction delivery form by releasing the automotive vehicle from the repossession program and files the signed auction delivery form.

If the foregoing activities occur at a satellite station, the satellite station reports a certain amount of the information back to the main station of the repossession agency by supplying the main station with paper copies of the appropriate reports. It is obvious, from the foregoing, that there are many manual, paper handling operations associated with repossessing personal property articles, particularly automotive vehicles; in fact, a count resulted in a total of 64 manual operations. All of these manual operations involve a considerable amount of paperwork, are subject to errors and personnel costs. The amount of paperwork can be appreciated from the fact that each lien holder request contains an average of five pages of facsimiled information, resulting in inefficient processing of lien holder orders. Such inefficient processing of lien holder orders has a detrimental effect on productivity, employee satisfaction and profitability of the agency processing the lien holder orders.

### SUMMARY OF THE INVENTION

One aspect of the invention is directed to a method of filling orders a supplier receives from a plurality of customers, wherein each order includes information about an article associated with the order. The articles of different orders are susceptible of having different characteristics and different locations. In the method, the supplier responds to the transmitted orders by preparing a first message associated with each order. The first message includes information about the characteristic of the article in connection with the order. The first message is electronically transmitted to a field unit including a transceiver coupled with a computer and a display coupled to be driven by the computer. The field unit is associated with an associate of the supplier who is assigned to perform the order. The electronic transmitting step includes wireless reception of the first message by the transceiver of the field unit to cause the transceiver of the field unit to couple the first message to the computer of the field unit. The computer responds to the first message to cause the display to display information about the character of the article associated with the order. The computer also causes the display to display information about a location in connection with the article. The associate responds to the display by: (a) going to the displayed location and (b) executing the order in connection with the article. The associate supplies the computer with an input indicative of the success of its efforts in connection with the article at the displayed location. The computer responds to the input supplied to it by the associate by preparing a second message commensurate with the input the associate supplies to the computer. The second message is coupled from the computer to the transceiver which transmits the second message to the supplier by a communication link including wireless transmission of the second message from the transceiver. The supplier responds to the second message by storing an indication that the order was successfully processed if the second message so indicates.

Another aspect of the invention relates to a system for filling orders a supplier receives from a plurality of customers, wherein each order includes information about an article associated with the order. The articles of different orders are susceptible of having different characteristics and different locations. The system comprises a supplier computer arrangement for preparing a first message associated with each order. The first message includes information about the characteristic of the article in connection with the order. A communication link coupled with the computer arrangement transmits the first message to a field unit including a transceiver coupled with a computer and a display. The field unit is an automotive vehicle in a fleet of automotive vehicles and is associated with an associate of the supplier who is assigned to perform the order. The communication link includes a wireless portion for enabling the first message to be received by the transceiver of the field unit. The transceiver and computer of the field unit are coupled together for causing the first message to be coupled from the transceiver to the computer. The computer responds to the first message for causing the display to display information about the character of the article associated with the order. The computer is also arranged for causing the display to display information about a location in connection with the article. The computer is arranged to respond to an input of the associate indicative of the success of the associate's efforts in connection with the article at the displayed location. The computer is also arranged to respond to the input supplied to it by the associate to prepare a second message commensurate with the input the associate supplies to the computer. The computer is coupled with the transceiver to couple the second message from the computer to the transceiver. The transceiver is arranged to be responsive to the second message to transmit the second message to the supplier computer by a communication link including wireless transmission of the second message from the transceiver. The supplier computer is arranged to respond to the second message and includes a storage arrangement for storing an indication that the order was successfully processed.

A further aspect of the invention relates to a method of repossessing personal property articles in response to orders from a plurality of lien holders holding liens on different articles to be repossessed. Each of the orders includes information about the identity of the article to be repossessed in connection with the order. In the method, the orders are transmitted to a repossession agency which responds to them by preparing a first message associated with each order. The first message includes information about the identity of the article to be repossessed in connection with the order. The first message is transmitted to a mobile field unit including a transceiver coupled with a computer and a display coupled to be driven by the computer. The field unit is associated with an associate of the agency who will attempt to repossess the article. The electronic transmitting step includes wireless reception of the first message by the transceiver of the field unit to cause the transceiver of the field unit to couple the first message to the computer of the field unit. The computer responds to the first message to cause the display to display information about the identity of the article to be repossessed in connection with the order. The computer also causes the display to display information about the likely location of the article. The associate responds to the display by: (a) going to the displayed location, (b) ascertaining whether the article is at the location, and (c) attempting to repossess the article if the article is at the location. The associate supplies the computer with an input indicative of the success of its repossession efforts at the displayed location. The computer responds to the input supplied to it by the associate by preparing a second message commensurate with the input the associate supplies to the computer. The second message is coupled from the computer to the transceiver which in turn transmits the second message to the agency by a communication link including wireless transmission of the second message from the transceiver. The agency responds to the second message by communicating to the lien holder that the article was successfully repossessed if the second message indicates the associate successfully repossessed the article.

An additional aspect of the invention relates to a system for repossessing personal property articles in response to orders from a plurality of lien holders holding liens on different articles to be repossessed, wherein each of the orders includes information about the identity of the article to be repossessed in connection with the order. The system comprises a computer arrangement connected to be responsive to inputs indicative of information in the orders. The computer arrangement prepares a first message associated with each order, wherein the first message for each order includes information about the identity of the article to be repossessed in connection with the order. A communication link transmits the first messages from the computer arrangement to a mobile field unit including a transceiver coupled with a computer and a display coupled to be driven by the computer. The field unit is associated with an associate of the agency who will attempt to repossess the article. The communication link includes a wireless portion for transmitting the first message to the transceiver which is coupled with the computer for causing the first message to be coupled to the computer. The computer responds to the first message to cause the display to display information about the identity of the article to be repossessed in connection with the order. The computer is coupled with the display for causing the display to display information about the likely location of the article. The computer responds to an input by the associate indicative of whether or not the associate was successful in repossessing the article. The computer responds to the inputs applied to it by the associate to prepare a second message commensurate with the input the associate supplies to the computer. The computer couples the second message to the transceiver. The transceiver is coupled with the computer to transmit the second message to the agency by a communication link including a wireless portion from the transceiver to the computer arrangement. The computer arrangement communicates to the lien holder that the article was successfully repossessed if the second message indicates the associate successfully repossessed the article.

Typically, the plural customers (e.g., lien holders) transmit orders to the supplier (e.g., repossession agency) in different formats and the supplier causes all the first messages to have the same format. In particular, the supplier includes a computer arrangement which: (a) puts the different orders in the different formats into the first messages which have the same format, and (b) prepares a third message indicating the associate successfully processed the order.

Typically, at least some of the different orders are transmitted by facsimile to the supplier, and the computer arrangement effectively includes a digital facsimile server and database server. The digital facsimile server puts the different orders in the different formats into orders having the same format, and the database server forms the first messages by responding to the orders having the same format, as derived by the facsimile server.

The first message includes a location associated with the order and the field unit computer responds to the first message by causing the display to display the location included in the first message. The associates are drivers who go to the displayed location by driving automotive vehicles to the displayed location.

Preferably, the communication link from the supplier to the field unit and the communication link from the field unit to the supplier include the Internet.

The supplier usually transmits to the field unit plural messages concerning a plurality of orders at different locations. The computer responds to the plural messages to cause the display to simultaneously display general information about the plurality of orders. The associate responds to the displayed general information to select one of the plurality of orders and the computer responds to the selection by the associate to cause the display to display detailed information about the selected order.

Preferably, a customer can determine the status of its order by accessing the computer arrangement via a communication link between the customer and the computer arrangement. The communication link between the customer and the computer arrangement preferably includes the Internet. The customer accesses the computer arrangement by transmitting to the computer arrangement via the Internet a password associated with the customer. The computer arrangement provides the customer with the status of its order via the Internet only in response to the computer arrangement determining that the transmitted password is associated with the customer.

In a preferred embodiment, the supplier includes a main station and at least one satellite station. Each of the stations receives orders from customers in proximity to that station and wirelessly transmits the first messages to field units in proximity to that station and wirelessly receives the second messages from field units in proximity to that station. The satellite station (a) transmits to the main station via the Internet the second messages it receives from field units, and (b) receives from the main station via the Internet the first messages which it transmits to field units in proximity to that satellite station. The main station responds to orders communicated by all customers of the supplier by forming the first messages and assigns the orders to the different stations of the supplier.

The above and still further objects, features and advantages of the present invention will become apparent upon consideration of the following detailed description of a specific embodiment thereof, especially when taken in conjunction with the accompanying drawings.

### BRIEF DESCRIPTION OF THE DRAWING

FIG. 1 is an overall system block diagram of a system for carrying out the method of a preferred embodiment of the present invention;

FIG. 2 is a block diagram of a preferred embodiment of equipment at the central station of the system of FIG. 1;

FIG. 3 is a block diagram of a preferred embodiment of equipment at an exemplary satellite station of the system of FIG. 1;

FIG. 4 is a block diagram of a preferred embodiment of equipment in an exemplary tow truck of the system of FIG. 1;

FIG. 5 is a drawing of indicia appearing on the display included in the equipment of FIG. 4, when the display simultaneously displays general information about plural orders received in the system of FIG. 1;

FIG. 6 is a drawing of indicia appearing on the display included in the equipment of FIG. 4, when the display displays specific information about one of the orders received in the system of FIG. 1;

FIG. 7 is a block diagram of a preferred embodiment of equipment at an exemplary customer facility of the system of FIG. 1; and

FIGS. 8A-D, together, are a flow diagram of operations the system of FIG. 1 performs in conjunction with a preferred embodiment of the invention.

### DETAILED DESCRIPTION OF THE DRAWING

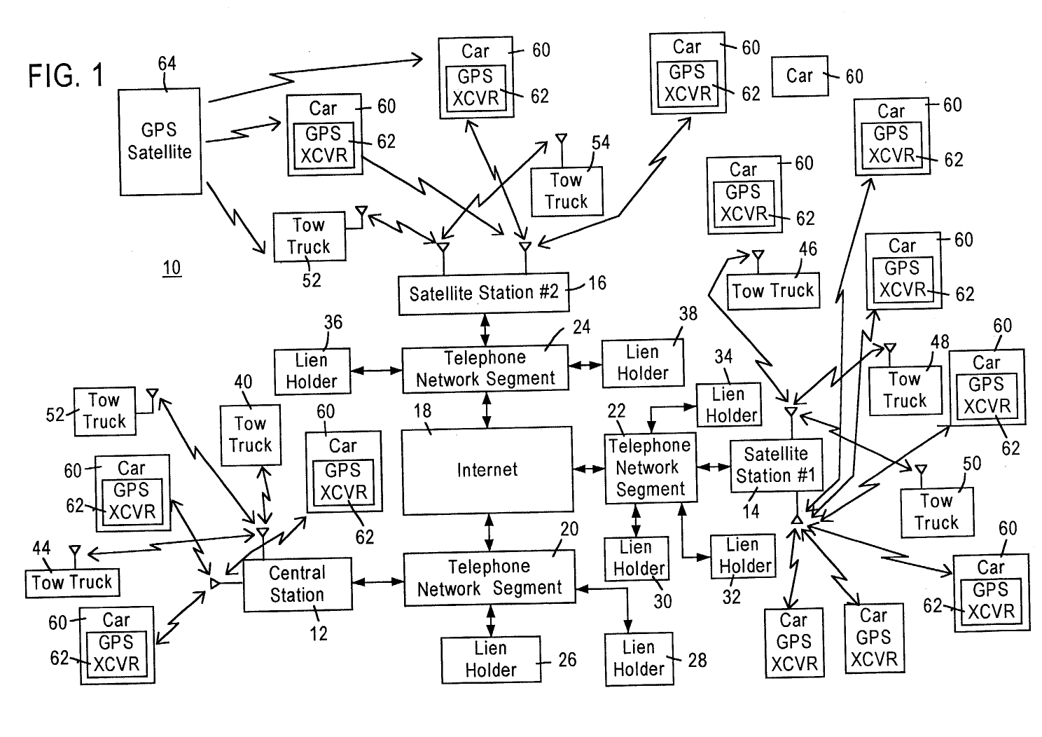

Reference is now made to FIG. 1 of the drawing wherein repossession system 10 is illustrated as comprising a repossession agency including central station 12 and satellite stations 14 and 16, all of which are in disparate locations and are connected to each other by a communication network including the Internet 18 which is respectively connected to stations 12, 14 and 16 by telephone network segments 20, 22 and 24. Telephone network segments 20, 22 and 24 respectively connect lien holders 26-38 in the vicinity of stations 12, 14 and 16 to central station 12 via an “800” telephone number. Telephone network segments 20, 22 and 24 and the Internet 18 establish direct connections between some of lien holders 26-38 and station 12 for e-mail messages.

When one of lien holders 26-38 desires to have an article of personal property, for example, an automotive vehicle (such as a car, truck or recreational vehicle) or a trailer mounted boat, repossessed by the repossession agency, the lien holder places an order including certain information, namely: (1) the name, street address, e-mail address, telephone facsimile number and telephone number for oral communications of the legal owner (usually the lien holder) of the property to be repossessed, as well as the account number of the lien holder associated with the order; (2) the name, residence street address, residence telephone number, social security number, and date of birth of the debtor; (3) the name, street address, and telephone number of the employer of the debtor; (4) information about the personal property article to be repossessed; if the article is an automotive vehicle, the year, make, model, license plate number and state, color, vehicle identification number, and codes concerning the vehicle keys; (5) the number of the loan, the due date of the loan, the past due amount of the loan, the loan monthly payment, the date of last payment, and the loan balance; and (6) whether the repossession is voluntary or involuntary. The person authorizing the repossession is required to sign his/her name to the order and the order date is required. The signature is an actual signature if the lien holder sends the order by facsimile to the agency; if the lien holder uses a computer to send the order to the agency by e-mail through the Internet, the order includes a “computer signature” of the authorizing person. The lien holder in some instances also includes special instructions with the order.

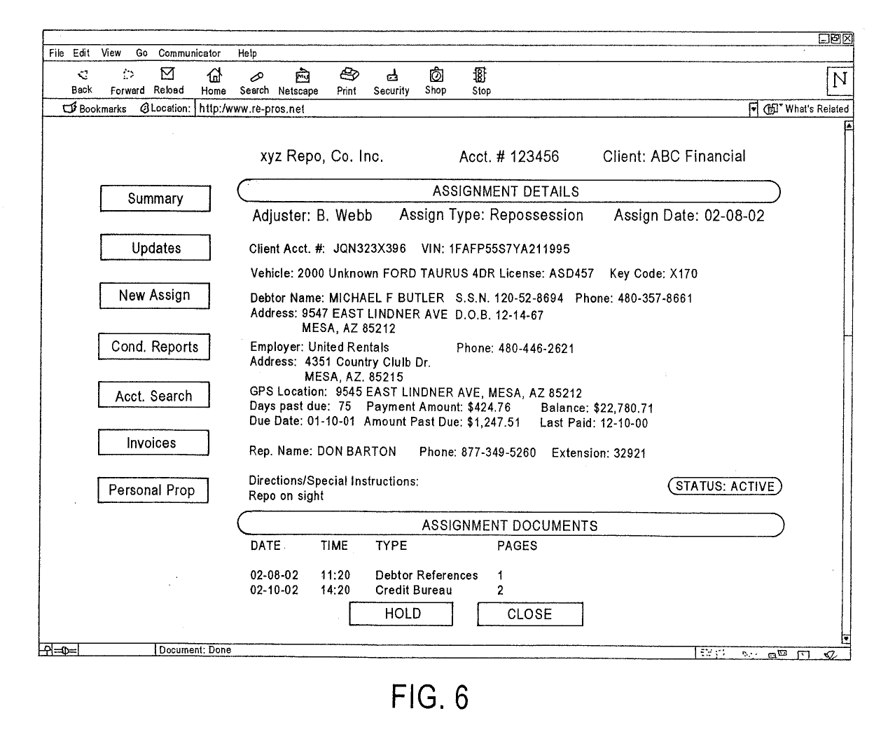

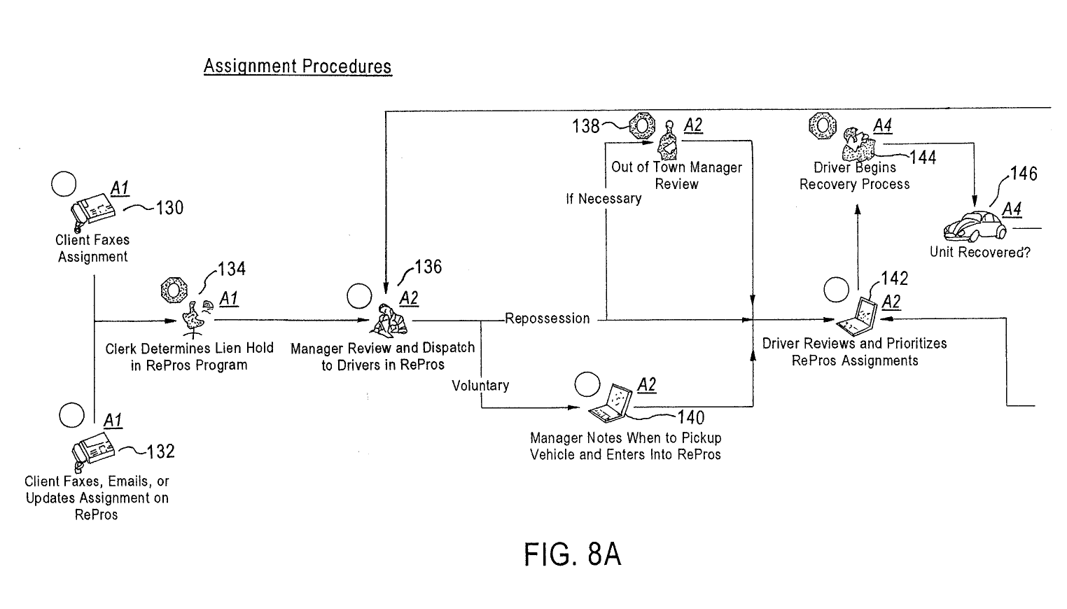

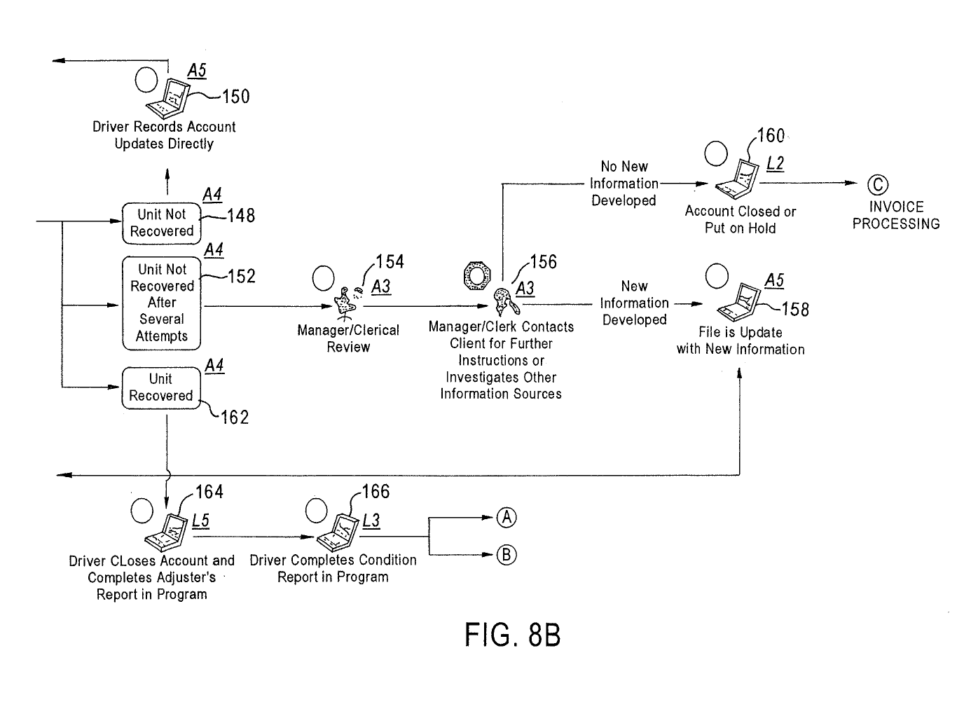

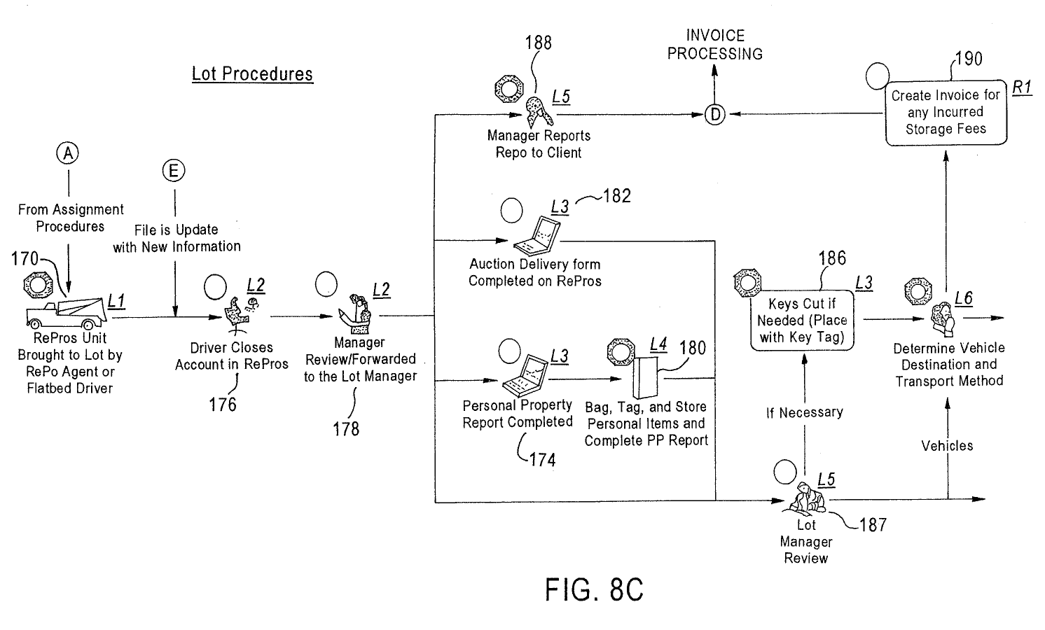

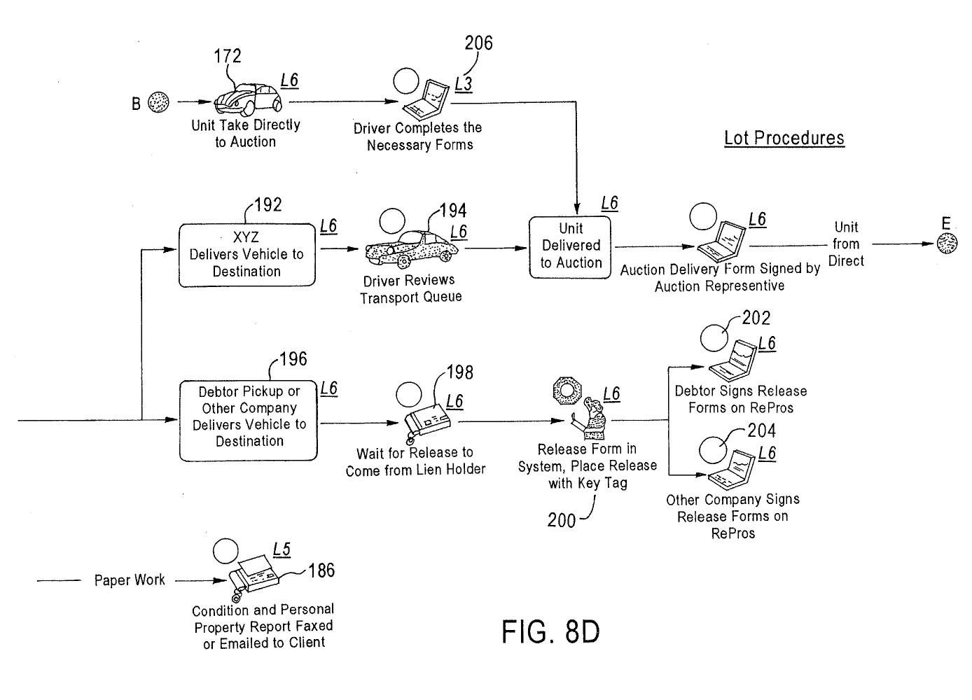

Different lien holders who place orders by facsimile and e-mail use different order formats to send orders to station 12 by facsimile. The lien holders who communicate with the agency by computer use an e-mail address of the equivalent of a Web server of a computer arrangement at central station 12 and send their orders by e-mail to the central station via the Internet 18 and the appropriate telephone network segments. The computer arrangement of central station 12 also includes the equivalent of a digital facsimile server which lien holders 26-38 can access by the telephone network with an “800” telephone number. The server responds to the order from the lien holder and drives a display at station 12 to display the order in tag image file format (TIFF). A data entry clerk at station 12 opens the TIFF, reviews the order, makes certain determinations (discussed infra in connection with FIG. 8) and prepares details about the lien holder's order in a uniform computer format (FIG. 6) that appears on a display at station 12. The computer at station 12 simultaneously drives one or two displays to simultaneously present the clerk with the order from the lien holder and the format of FIG. 6 to enable the information to be presented in the format of FIG. 6.

The computer arrangement of central station 12 and the computers of the system of FIG. 1 are programmed (as described infra) to respond to the orders so that they prepare in a “paperless” manner a first message including instructions for associates of the agency, e.g., tow truck drivers, for repossession of the personal property article associated with each lien holder order. Central station 12 communicates each of these first messages via e-mail to one of stations 14 or 16 to associates of the agency, e.g., tow truck drivers. In any event each first message goes eventually to an associate who has the responsibility of repossessing the article. If the associate is a tow truck driver, the driver drives his mobile field unit, e.g., tow truck, to the expected location of the article and attempts to repossess the article identified in the first message. Each first message is in e-mail format and includes the information in each lien holder order, as well as data that central station 12 or a satellite station 14 or 16 appends to each order. The appended information includes a number the repossession agency assigns to the order, the date the assignment is sent to the driver, the name of the driver and the e-mail address of the mobile field unit, for example.

For orders central station 12 receives from lien holders for articles to be repossessed, wherein the articles are in proximity to satellite stations 14 and 16, the central station sends the first messages associated with such orders to computers at satellite stations 14 and 16 via the Internet 18 and telephone network segment 20, as well as segments 22 and 24, as appropriate. Personnel at stations 14 and 16 assign the repossession job to an associate close to the station that received the e-mail. Satellite stations 14 and 16 respond to the first messages they receive by way of the Internet 18 to wirelessly transmit to the e-mail address of the assigned tow truck the first messages associated with such orders. The assigned tow truck, i.e., mobile field unit, is in proximity to and associated with one of satellite stations 14 or 16. Alternatively, for orders central station 12 receives from lien holders for articles to be repossessed in proximity to the central station, the central station wirelessly transmits via e-mail the first messages associated with such orders to mobile field units in proximity to the central station.

To these ends, system 10 includes tow trucks 40, 42 and 44 which are associated with and in proximity to central station 12, tow trucks 46, 48 and 50 and associates in addition to tow truck drivers 52 and 54 which are associated with and in proximity to satellite station 14, and tow trucks which are associated with and in proximity to satellite station 16. A wireless wide area network (WAN) provides an e-mail computer communication link between each of stations 12, 14 and 16 and the associates associated with and in proximity to each of the stations. To these ends, each of tow trucks 40-54 and the other associates includes a transceiver coupled with a computer having an e-mail address enabling the computer of the tow truck and the other associates to be responsive to the first messages stations 12, 14 and 16 derive. The computer at each of tow trucks 40-54 and the other associates drives a display for enabling the driver of a particular tow truck to (1) simultaneously be provided during first intervals with general information about a plurality of lien holder orders, and (2) be provided during second intervals with specific information about one of the orders.

The tow truck drivers and other associates respond to the displayed information presented during the second intervals by going to the indicated location of the article to be repossessed and attempting to perform the repossession. The tow truck drivers and other associates report the success or failure of the repossession attempt by supplying an input to the computer on the tow truck or carried by the other associate; the input is supplied by keyboarding or speaking into a microphone. The tow truck drivers also perform the same type functions as are performed with a mouse or by pressing a stylus on a display.

If the tow truck driver or other associates is successful in repossessing the article, the associate inspects the repossessed article shortly after leaving the repossession scene. The associate then prepares a personal property report, i.e. a report itemizing objects in the car or boat and a report indicating the condition of the article by keyboarding or speaking into the microphone. The associate thus produces “paperless” personal property and condition reports in the field.

The computer of the associate responds to the success or failure input and the personal property and condition reports, if applicable, by preparing a second message including (1) an indication of the repossession agency order number, (2) the success or failure of the repossession attempt, (3) the personal property and condition reports if appropriate, and (4) the e-mail address of the “Web server” of central station 12. The associate transmits the second message back to the proximate station with which it is associated by way of the transceiver of the associate and a wireless wide area network including a vehicle of the associate and the proximate station. If the associate driver is successful in repossessing the personal property article, the associate drives the tow truck with the article in hand to an impoundment lot at the proximate station.

If the instruction associated with the first message is being carried out by any one of tow trucks 40-44, the communication between such a tow truck and central station 12 is only by way of the wireless wide area network between station 12 and the particular tow truck 40-44 receiving the first message and transmitting the second message. If, however, the instruction is being carried out by any of tow trucks 46-50, there are communications between that tow truck and satellite station 14 by way of the wireless wide area network between them. Central station 12 communicates the first message for such a tow truck to station 14 by way of the Internet 18 and telephone network segments 20 and 22. Personnel at station 14 modify the first message and station 14 relays the modified first message to the tow truck 46-50 assigned to the order by the personnel at station 14. The first message is relayed by way of the wireless wide area network associated with station 14. The assigned tow truck 46-50 sends the second message including the result of the repossession attempt to station 14 by way of the wireless wide area network. Station 14 relays the second message to station 12 by way of the Internet 18 and telephone network segments 20 and 22. If the instruction is being carried out by either of tow trucks 52 or 54, there are communications of the first and second messages between stations 12 and 16 and between station 16 and one of trucks 52 or 54 in the same manner as the communications of the first and second messages between stations 12 and 14 and one of tow trucks 46-50 via satellite station 14. The central station “Web server” has an e-mail address causing the Web server to respond to the second messages that tow trucks 40-54 transmit to it, either directly or via stations 14 and 16.

The computer arrangement of central station 12 includes the equivalent of a database server which responds to the second messages that tow trucks 40-54 transmit and are received by the “Web server” of the central station. The database server includes a significant amount of memory and can include a speech recognition program for converting speech signals of the tow truck drivers into digital data signals, such as alphanumeric representations. The “database server” at station 12 responds to the second messages by producing third messages which track the results indicated by the second messages.

Each lien holder having at its facility a computer with Internet access can, under certain circumstances, retrieve the third messages for orders that lien holder placed to determine the current status of any of its orders. Such a lien holder can retrieve a third message by activating its computer to transmit to the computer arrangement at central station 12 a message including: (1) the e-mail address of the “Web server” of central station 12, (2) a personal identification number (PIN) the repossession agency assigned to the lien holder, (3) the lien holder identity, and (4) information about the article being repossessed or the repossession agency order number associated with the article being repossessed. (If desired, the repossession agency uses the Internet to transmit to the computer of the lien holder the agency order number associated with the article being repossessed. Such a transmission is shortly after the repossession agency assigns its order number to the order the lien holder submits). The computer arrangement “database server” of station 12 responds to the message from the requesting lien holder by checking the PIN, and, if appropriate, retrieves the requested information from the memory it includes. The computer arrangement forms a third e-mail message including the retrieved information and station 12 sends the third message to the requesting lien holder.

The computer arrangement of central station 12 closes a particular order if the article has been repossessed (automatic closing by the computer arrangement) or because a manager of the repossession agency or the lien holder has determined that repossession of the article is not feasible. In response to the computer arrangement closing a particular order, the computer arrangement computes the amount of an invoice for review by a repossession agency manager. Upon completion of the managerial review, the computer arrangement creates an invoice which is sent to the lien holder by regular mail, e-mail or facsimile. In addition, the computer arrangement sends invoice data for several orders in batches directly to the accounting department computer of the repossession agency.

If the article has been successfully repossessed, the database server portion of the computer arrangement of station 12 prepares the third message by retrieving from its memory the second message for the order associated with the article and extracts the personal property and condition reports from the retrieved second message. The database server portion of the computer arrangement sends the extracted personal property and condition reports of the third message to a printer at station 12 or facsimile server portion of the computer arrangement at station 12 if communication with the lien holder is by regular mail or facsimile, respectively. If communication with the lien holder is by e-mail, the computer arrangement database server portion sends the extracted reports of the third message to the Web server of the computer arrangement of station 12, which Web server relays the reports to the lien holder e-mail address via the Internet 18.

The database server of station 12 can also respond to the information in the second message by retrieving the information necessary to prepare an auction delivery form for the repossessed personal property article. The database server supplies the information necessary to prepare the auction delivery form to a printer at the station where the repossessed article is impounded. If impoundment is at station 12, the database server drives a printer at station 12. If impoundment is at station 14 and 16, the database server drives a printer at that station via the Internet. A manager of the impoundment lot retrieves the printed auction delivery form and gives it to the driver of a delivery truck for the articles being sent to auction.

One instruction the first message includes is the location of the article to be repossessed. As previously indicated, each order includes the addresses of the residence and workplace of the debtor, which are likely locations of the article to be repossessed. In some instances, this is all the information the associate (e.g. tow truck driver) needs to repossess the article. In other instances, the location of the article cannot be accurately correlated to the addresses of the residence and/or workplace of the debtor. In consequence, many lien holders surreptitiously install global positioning system (GPS) transceivers in automotive vehicles and boats on which they hold liens.

Hence, many of cars 60 of system 10 include GPS transceivers 62 which communicate with GPS satellite 64. Associated with each of GPS transceivers 62 is an RF transceiver (not shown) which is activated into a transmit mode by the station 12, 14 or 16 in closest proximity to a car about to be repossessed. The activated RF transceiver relays the GPS derived location indication of the particular car to the station which activated the RF transceiver. If the station which activated the RF transceiver of the car to be repossessed is central station 12, the computer arrangement at station 12 causes the first message as transmitted to the assigned tow truck 40-44 to include the GPS derived location indication of the particular car to be repossessed. If the station which activated the RF transceiver of a car to be repossessed is satellite station 14 or 16, a computer arrangement at that satellite station relays the GPS derived location indication of the particular car to be repossessed back to central station 12 by way of the Internet 18, telephone network segments 20 and telephone network segment 22 or 24, as appropriate. The computer arrangement at central station 12 responds to the GPS location indication relayed to it by satellite station 14 or 16 and includes that information in the first message associated with the repossession order of the particular car.

The first message is constantly updated, if necessary, to include the location of a moving car to be repossessed. It is to be understood, however, that an article is not to be repossessed while the debtor is in close proximity to the article and that the tow truck driver is to pursue moving vehicles only as a last resort, and even then is to wait until after the debtor is no longer in close proximity to the article before attempting repossession.

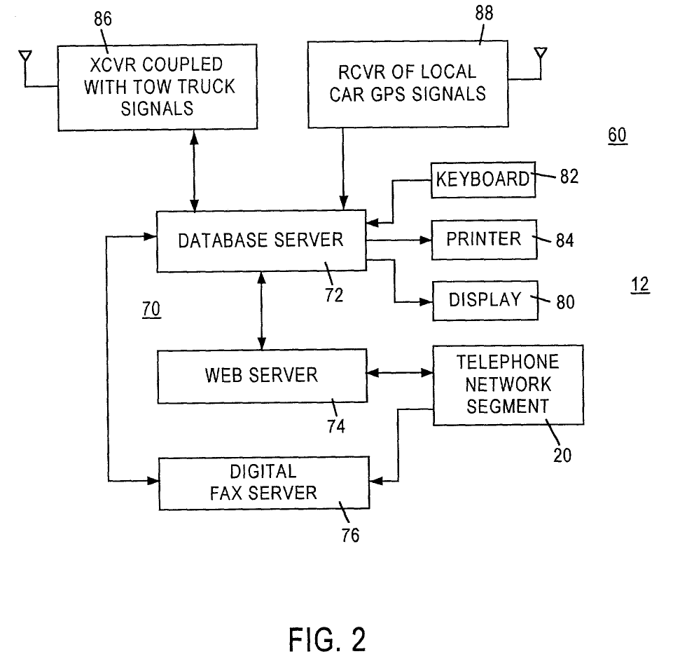

Reference is now made to FIG. 2 of the drawing, a block diagram of a preferred embodiment of central station 12. Central station 12 comprises computer arrangement 70 including the equivalent of database server 72, Web server 74 and digital facsimile server 76. In a device that has actually been built, database server 72, Web server 74 and digital facsimile server 76 are incorporated in a Linux Networx Evolocity cluster (that is, parallel processing) system including six nodes containing: (1) Intel Pentium III, 933 MHz processors, (2) two 12 port 10/100 interconnect switches, and (3) a Linux Cluster WorX software and hardware management tool. Two of the six nodes act as hosts which serve facsimiled orders from lien holders to the other four nodes and thus are effectively digital facsimile server 76.

Database server 72 and Web server 74 are coupled with each other so that e-mail communication between the database server and the Internet 18 is by way of telephone network segment 20, which is directly connected to the Web server. E-mail communication between database server 72 and the Internet 18 includes the first messages that central station 12 transmits to tow trucks 46-54, the second messages tow trucks 46-54 transmit to stations 12, 14 and 16 and orders placed by lien holders who choose to e-mail, rather than fax, their orders to station 12.

Telephone network segment 20 also supplies facsimiled orders from lien holders 26-38 to digital facsimile server 76. Digital facsimile server 76 processes the facsimiled lien holder orders, which have different formats depending on the lien holder, in TIFF to enable the entry clerk to convert them into an electronic document having a single digital format. Digital facsimile server 76 supplies the electronic documents representing the facsimiled lien holder orders to database server 72. Server 72 supplies display 80 with the contents of the electronic document, regardless of whether the electronic document was derived (1) by converting a facsimiled lien holder order or (2) directly in response to an e-mailed lien holder order.

A data entry clerk working at display 80 assigns a repossession agency account number to each lien holder order and enters that information and other information, e.g. the vehicle identification number (VIN), name and address of debtor, into the computer system of station 12 by activating keyboard 82 and a mouse which are connected to supply signals to database server 72. The mouse can be used to designate, by clicking, the lien holder from a lien holder menu, (i.e. list) the computer causes display 80 to display to the data entry clerk. The mouse can be used to enter other information, e.g. vehicle brand, color, body type etc. from associated menus. The data entry clerk then activates the mouse to cause database server 72 to e-mail the order to the computer arrangement at the appropriate one of stations 12, 14 or 16, depending on the location of the article to be repossessed. Database server 72 is also connected to printer 84, to cause the printer to print documents, such as the auction delivery form, for repossessed personal property articles delivered to central station 12.

Central station 12 also includes RF transceiver 86, coupled by a wireless wide area network to transceivers on tow trucks 40-44 in the vicinity of station 12, and RF receiver 88 coupled by a radio link to GPS receivers in lien holder owned cars 60 in the vicinity of station 12. Transceiver 86 and receiver 88 are coupled via Web server 74 with database server 72 so that e-mail messages are coupled in both directions between the database server and transceiver 86, while receiver 88 supplies server 72 with signals indicative of the location and identity of lien holder owned cars 60 in the vicinity of station 12. Transceiver 86 transmits to tow trucks 40-44 e-mail messages that originate at database server 72 and contain lien holder order information. Transceiver 86 receives e-mail messages from tow trucks 40-44 containing, inter alia, the results of repossession attempts and supplies these received e-mail messages to database server 72.

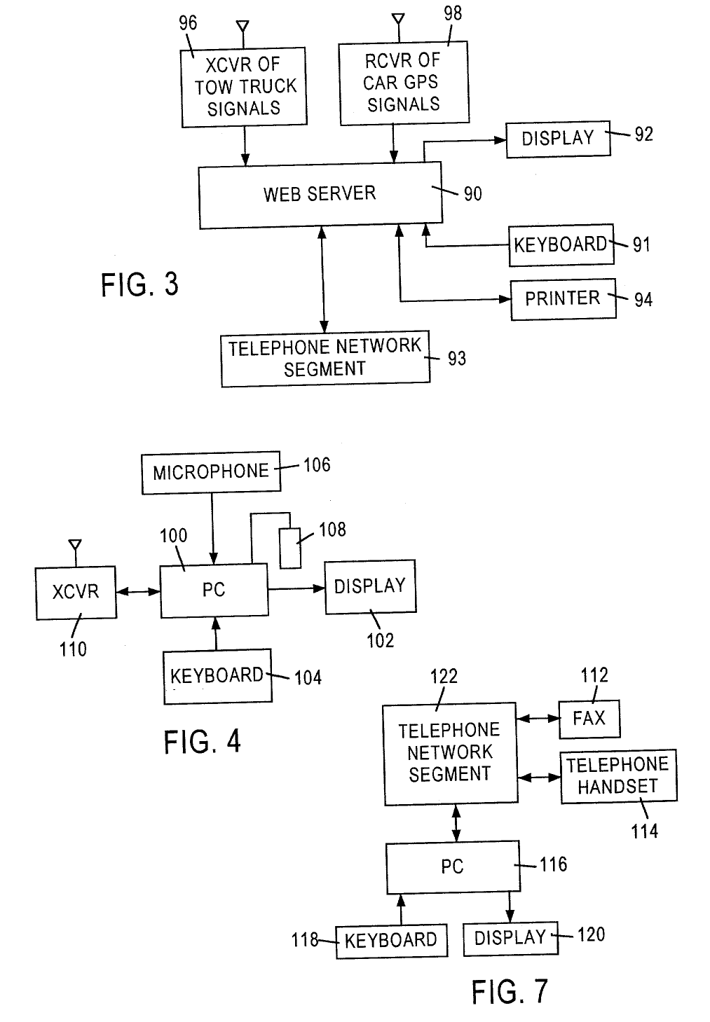

Reference is now made to FIG. 3 the drawing, a block diagram of equipment included at each of satellite stations 14 and 16. Each of satellite stations 14 and 16 includes a computer arrangement comprising Web server 90, keyboard 91 (which supplies the Web server with input signals), display 92 and printer 94; both the display and printer are responsive to output signals of the Web server. Web server 90 is connected to RF transceiver 96 and RF receiver 98 which perform the same functions and operate in the same manner in connection with the tow trucks and lien holder owned cars in the vicinity of the particular satellite station as transceiver 86 and receiver 88 at central station 12. The Web servers at satellite stations 14 and 16 are respectively connected to telephone network segments 22 and 24.

Web server 90 responds to e-mail messages from central station 12, which messages include lien holder order information for the repossessed articles in the vicinity of the particular satellite station. Web server 90 responds to these e-mail messages by activating display 92. A manager of the satellite station responds to the messages displayed on display 92 and assigns the repossession associated with each order to a tow truck driver associated with the particular satellite station 14 or 16. The manager activates keyboard 91 with an indication of the assigned tow truck driver and the e-mail address for the tow truck assigned to that driver. Web server 90 sends the resulting modified e-mail to central station 12, where data base server 72 modifies the stored electronic document for the order to include the added driver and e-mail address information. Station 14 or 16 also sends the modified electronic document to the e-mail address of the assigned tow truck. Web server 90 of station 14 or 16 supplies the modified e-mail to transceiver 96 which wirelessly transmits it to the assigned tow truck.

When the assigned driver has repossessed the article and completed the personal property and condition reports, transceiver 96 receives a wireless second message from the tow truck. The second message includes the reports and an indication of the successful repossession. Transceiver 96 sends the second message to Web server 90, which e-mails the second message to central station 12 via the Internet 18.

Database server 72 at station 12 responds to the second message by modifying the electronic document the database server stores for the order so the successful repossession indication and the reports are added to the stored message. The database server also at this time generates an electronic auction delivery form. Database server 72 then e-mails the modified electronic document and the auction delivery form to Web server 90 at the station 14 or 16 associated with the assigned tow truck. Web server 90 responds to the modified electronic document by driving display 92 with which the Web server is coupled so the satellite station manager can review the results of the repossession. Web server 90 responds to the electronic auction delivery form by activating printer 94 with which the Web server is coupled so printer 94 produces a hard copy of the auction delivery form.

Reference is now made to FIG. 4 of the drawing, a block diagram of the equipment included in each of tow trucks 40-54. Each of tow trucks 40-54 includes personal computer 100 which has an assigned e-mail address and is connected to drive display 102. Personal computer 100 is responsive to input signals from keyboard 104, microphone 106, and stylus 108 which is selectively pressed against display 102 to perform the same type functions as a mouse cursor. In the system actually constructed, personal computer 100, display 102, keyboard 104, microphone 106 and stylus 108 are included in Voice Tablet Mobile Pen computers available from Intelliworxx Corp., Sarasota, Fla.

Personal computer 100 is connected with RF transceiver 110 that transmits signals to and receives signals from transceiver 96 at satellite stations 14 or 16 or transceiver 86 at central station 12, whichever station is associated with the tow truck including transceiver 110. Transceivers 86, 96 and 110 are parts of wireless wide area networks for communicating e-mails between the tow trucks and stations 12, 14 and 16. Personal computer 100 can include an analog to digital converter for converting into digital signals speech of the tow truck driver that microphone 106 transduces into electric analog signals. These digital, speech representing signals are transmitted from the tow trucks to station 12 directly or to station 14 or 16, thence to station 12 via the Internet 18. Database server 72 converts into alphanumeric data signals the digital voice signals that the analog to digital converter of personal computer 100 derives.

When the tow truck driver has attempted to complete a repossession assignment, the driver activates keyboard 104 and/or speaks into microphone 106 to provide personal computer 100 with an input indicative of the results of the assignment. If the tow truck driver is successful in completing the repossession assignment, the driver prepares condition and personal property reports by speaking into microphone 106 and/or activating keyboard 104 and stylus 108. The assignment results, and if applicable, the condition and personal property reports, form the previously discussed second message. If the tow truck driver keyboards the condition and personal property reports, personal computer 100 responds to the second message by supplying the second message to display 102 so the tow truck driver can determine if the contents of the second message are consistent with the input indicative of the assignment results and the prepared reports.

Personal computer 100 also responds to the second message by preparing an e-mail including the contents of the second message. If the tow truck driver determines that the display of the second message is consistent with the inputs the driver supplied to personal computer 100, the driver uses stylus 108 to activate a “send” button on the display. If the tow truck driver dictates the reports into microphone 106, the driver uses stylus 108 to activate the “send” button upon completion of the dictation. Personal computer 100 responds to activation of the “send” button to supply to transceiver 110 the e-mail that includes the second message. Transceiver 110 relays the e-mail including the second message to the station 12, 14 or 16 with which the tow truck including the transceiver is associated.

Transceiver 110 responds to RF signals from the transceiver of the station 12, 14 or 16 with which a particular tow truck is associated to supply personal computer 100 with first messages which are to be sent to the e-mail address of personal computer 100 of the particular tow truck. Personal computer 100 responds to such first messages by activating display 102 so that the display simultaneously provides the driver of the particular tow truck with general information about several of the automotive vehicles or trailer mounted boats the driver is assigned to repossess. When the tow truck driver wants to obtain specific information about a selected one of the displayed automotive vehicles or boats, the driver places stylus 108 on the line of display 102 containing general information about the selected article and activates the stylus by pressing against the display. Personal computer 100 responds to the activated stylus to retrieve specific information from the personal computer about the first message associated with the selected article, and thereby cause display 102 to display detailed information about the selected article.

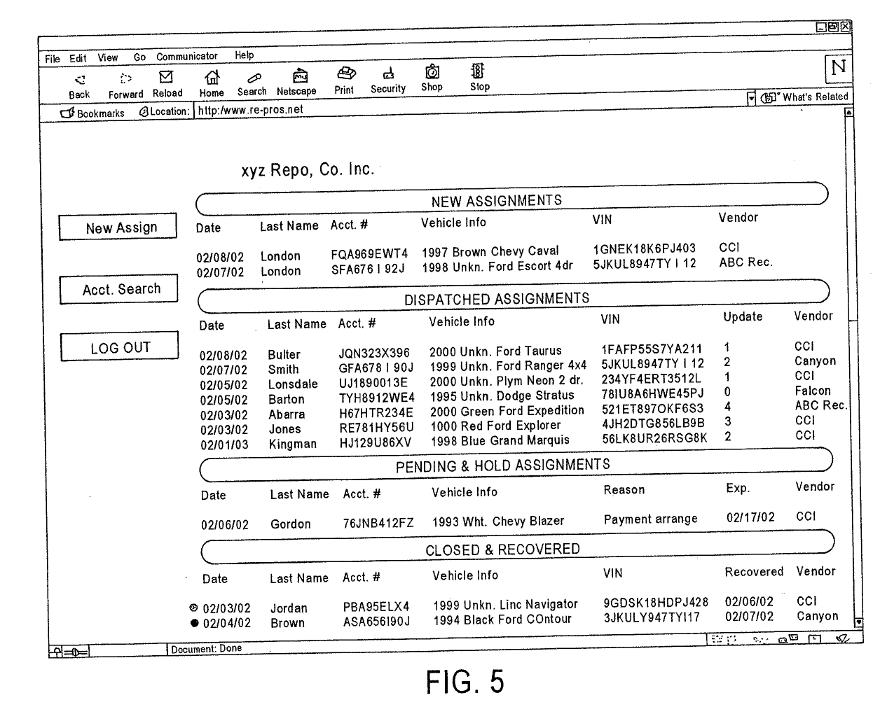

FIG. 5 is an illustration of exemplary indicia on display 102 when the display simultaneously provides a particular tow truck driver with general information about several cars the driver has been assigned to repossess. Database server 72 at central station 12 supplies personal computer 100 and display 102 with the information in the display of FIG. 5 by e-mail so that the memory requirements of computer 100 are minimal.

The display of FIG. 5 is divided into four segments, entitled “NEW ASSIGNMENTS”; “DISPATCHED ASSIGNMENTS”; “PENDING AND HOLD ASSIGNMENTS”; and “CLOSED AND RECOVERED.” Each of the segments includes one or more lines containing general information about one vehicle assigned to the particular tow truck driver for repossession. The general information on each line includes (1) the date the particular tow truck driver received the assignment, (2) the last name of the debtor, (3) the order number the repossession agency assigned to the lien holder's order (referred to on the display as “Acct. #”), (4) general information about the car to be repossessed, (5) the vehicle identification number of the car to be repossessed (referred to on the display as “VIN”), and (6) the vendor of the car. In addition, the “DISPATCHED ASSIGNMENTS” segment includes a column with the heading “Update” which signifies the number of attempts which have been made to repossess the car. The “PENDING AND HOLD ASSIGNMENTS” segment includes a column with the heading “Reason” which indicates the reason why there is a hold on repossession assignments listed in that segment. The “CLOSED AND RECOVERED” segment includes a column with the heading “Recovered” which indicates the date the car(s) in that segment were repossessed.

The display of FIG. 5 also includes a typical e-mail address region, indicated as “http://www.re-pros.net.” The e-mail address in this region is the address of central station 12.

The display of FIG. 5 also includes three regions respectively containing the following indicia: “New Assign”; “Acct. Search”; and “LOG OUT.” The “New Assign” region blinks when transceiver 110 on the particular tow truck receives and supplies to personal computer 100 of that tow truck a first message, of the type previously discussed, so the driver of the particular tow truck is advised visually that there is a new order in the “NEW ASSIGNMENTS” segment. When the tow truck driver wants to log out from personal computer 100, the driver moves stylus 108 to the “LOG OUT” region and presses the stylus against that region. Personal computer 100 responds to such activation of stylus 108 by turning itself off. The tow truck driver presses stylus 108 against the “Acct. Search” region when the driver wants to obtain detailed information about one of the cars listed on the display of FIG. 5. The resulting activation of stylus 108 activates personal computer 100 to (1) cause the “Acct. Search” region to blink, and (2) enable the tow truck driver to obtain detailed information about a particular one of the cars listed on the display by moving stylus 108 to the display line associated with the particular car. The tow truck driver obtains the detailed information by pressing stylus 108 against the display line associated with the particular car while the “Acct. Search” region is blinking.

FIG. 6 is an illustration of exemplary indicia on display 102 as a result of the tow truck driver obtaining detailed information by pressing stylus 108 against the display line of FIG. 5 associated with a particular car to be repossessed. The indicia on FIG. 6 include all of the information in the first message associated with a particular car to be repossessed. In addition, FIG. 6 includes a line entitled “GPS location:” which indicates the location of the car to be repossessed, as coupled by e-mail from central station 12 to the tow truck via the Internet and the satellite station 14 or 16 associated with the tow truck, if applicable. The indicia illustrated in FIG. 6 also includes several additional regions, including “Cond. Reports” and “Personal Prop” regions. When the tow truck driver is ready to prepare the condition and personal property reports the driver presses stylus 108 against the “Cond. Reports” and “Personal Prop” regions to enable personal computer 100 to signal to central station 12 that these reports are being prepared and transmitted to it.

FIG. 7 is a block diagram of exemplary equipment included at a facility of one of lien holders 26-38. The equipment of such a lien holder includes a facsimile machine 112, a telephone handset 114 and possibly a personal computer 116 with associated keyboard 118 and display 120. Personal computer 116 includes an e-mail address which might be assigned to it by the repossession agency. In any event, if personal computer 116 is connected to the Internet 18, the repossession agency must be advised of the e-mail address of the personal computer so central station 12 can send information about the repossession efforts to the lien holder. Each of facsimile machine 112, telephone handset 114 and personal computer 116 is connected to telephone network segment 122 to provide a telecommunication link between the lien holder and central station 12. If the lien holder wants to find out information about one of its repossession orders, the lien holder is provided by the repossession agency with a personal identification number (PIN) which the lien holder must supply to personal computer 116 by way of keyboard 118 to access database server 72 at central station 12. The lien holder also must supply its order number for the order about which it wants information to personal computer 116 by way of keyboard 118. The lien holder transmits by e-mail the PIN and order number from its computer 116 to database server 72 by way of the Internet 18.

In the system of FIGS. 1-4 and 7, the operations indicated in FIG. 8 are performed. FIG. 8 includes FIGS. 8A-D, wherein the steps illustrated in FIGS. 8A and 8B are generally associated with assignment procedures, that is, repossessing the vehicle, while the steps illustrated in FIGS. 8C and 8D are generally associated with lot procedures, i.e., processing the vehicle after it has been repossessed and brought by a tow truck driver to an impoundment lot. In FIG. 8, operations or steps which are performed automatically or semiautomatically, i.e., at least partially with the computer system, have a circle next to them, while operations which are performed manually have an octagon next to them.

The first operation is for the lien holder, i.e., client of the repossession agency, to send via facsimile transmission an order, i.e., assignment, to central station 12, as indicated by operation 130. The order includes the information set forth in paragraph 31 of this document. Alternatively, the client sends the order to central station 12 by e-mail, as indicated by operation 132. The client can also send updates of the order to central station 12 via e-mail or facsimile. The order or order update is received by the digital fax server 76 at station 12 and is displayed as a tiff on display 80. During operation 134 a data entry clerk at station 12 opens the tiff and reviews the image on display 80, which image is a reproduction of the facsimile sent by the lien holder.

The data entry clerk determines from the displayed facsimile whether the order is to be executed by central station 12 or one of satellite stations 14 or 16. The data entry clerk also determines if all the information on the facsimile transmission is clear and legible. The data entry clerk calls the lien holder if the clerk has any questions regarding the order as it appears on display 80. If no additional information is necessary, the data entry clerk enters the assignment into the system by clicking on a virtual data entry “button” on display 80. The data entry clerk than enters the information from the facsimile, as it appears on display 80, by filling in the format illustrated in FIG. 6. Information such as client account number, debtor name and address, and VIN is placed in the format by the data entry clerk activating keyboard 82 at station 12. Other information, such as the name of the client of the repossession agency, vehicle year, vehicle brand, vehicle model, vehicle color and whether the repossession is voluntary or involuntary, is entered from menus on display 80 by clicking a mouse; for convenience, no mouse is specifically illustrated in FIG. 2 and the mouse is considered as part of keyboard 82. The data entry clerk also uses a menu and the mouse to enter the name of the representative of the lien holder who made the repossession request. Database server 72 at station 12 crosschecks the name of the representative with the name of the lien holder to be sure that the representative and the lien holder match, to preclude an error by the data entry clerk for the names of the representative and the lien holder. If such an error has been made, database server 72 activates display 80 accordingly.

Preferably, database server 72 activates display 80 to cause the data entry clerk to initially enter the names of the representative and the lien holder; if there is no error in these entries database server 72 activates display 80 to cause display of an “Assignment Type” menu including the affair is retrieval assignment types, i.e., involuntary, voluntary, field visit, tow, investigations and lease return. The specific information about the vehicle being repossessed is entered either partially from menus, as indicated above, or by activating keys of keyboard 82. If the vehicle identification number most recently sent by the lien holder was previously entered into the system, database server 72 activates display 80 to present a yes-no menu asking the data entry clerk if the assignment associated with the previously entered vehicle identification number should be attached to the currently processed assignment, i.e., if the currently processed assignment is an update of an assignment that was previously entered into the system. If the currently processed assignment is an update, database server 72 supplies display 80 with an update screen which enables the additional and/or modified information to be inserted into the information in the format of FIG. 6. For example, the updated information can include an additional address where the vehicle to be repossessed is located.

If the representative of the lien holder has e-mail and would like the progress of the order, i.e. assignment, to be sent to him via e-mail, the data entry clerk enters the e-mail address of the representative into the format of FIG. 6. Simultaneously, station 12 sends an e-mail transmission to the representative by way of the Internet 18.

The last operation the data entry clerk performs during step 134, which operation is optional, is keyboarding any special instruction or instructions about the assignment into the screen of FIG. 6. When the data entry clerk has entered all of the data into the screen of FIG. 6 the clerk activates a virtual button on display 80, causing the screen of FIG. 6 to be transferred by e-mail or a local area network at station 12 to a computer arrangement of the manager of station 12. The computer arrangement of the manager of station 12 includes the usual processor, display, printer, keyboard, mouse, etc. The data entry clerk then begins to process the tiff associated with the next order or assignment from a lien holder.

During step 136 the screen of FIG. 6 appears on the display of the manager of station 12. The manager station 12 reviews the material included on the screen of FIG. 6 to make sure the data entry clerk correctly entered the information. During operation 136 the manager of station 12 determines if the order is to be filled at station 12 or one of satellite stations 14 or 16. If the manager of station 12 determines that the order is to be filled at one of satellite stations 14 or 16, the manager of station 12 sends the order by e-mail via the Internet 18 to the manager of station 14 or 16. The manager of the satellite station 14 or 16, during operation 138, reviews the order sent to him via e-mail from station 12. Because the remaining operations performed by the managers of stations 12, 14 and 16 and the tow truck drivers associated with the stations are the same, only operations performed with station 12 are described.

The first thing the manager of station 12 determines from the information on his computer display is whether the retrieval of the vehicle is voluntary or involuntary. If the retrieval is voluntary, which occasionally is the case for repossessed vehicles and is usually the case for retrieved leased vehicles, operation 140 is performed. During operation 140 the time when, and place where, retrieval is to occur are entered into the screen of FIG. 6. The station manager obtains this information from the lien holder or leasee by telephone or has a clerk at station 12 obtain this information by sending such a clerk an e-mail. The station manager or clerk at station 12 performs operation 140.

After the manager of station 12 determines, during step 136, whether the retrieval of the vehicle is voluntary or involuntary, the station manager decides which associate, for example, tow truck driver, is to receive the assignment to retrieve the vehicle. The manager station of 12, during operation 136, inserts, either by keyboarding or clicking with a mouse from a menu, the name of the associate into the “Adjuster” field associated with the format of FIG. 6. This results in database server 72 supplying an e-mail screen to the display of the manager of station 12; the e-mail screen includes the e-mail address of the associate who has the assignment. If the retrieval is not voluntary, the station manager, upon the completion of step 136, sends an e-mail including the screen of FIG. 6 to the associate assigned to perform the retrieval. This e-mail is sent via a wireless communication link between central station 12 and one of tow trucks 40-44, for example tow truck 40, as selected by the manager of station 12 and indicated by the e-mail address of the associate. If the retrieval is voluntary, the station manager or clerk who performs operation 140 sends such an e-mail to the associate upon the completion of step 140.

During operation 142, the driver of tow truck 40 is apprised of the new assignment. During operation 142, transceiver 110, FIG. 4, receives the e-mail containing the new assignment and supplies it to personal computer 100, which in turn drives display 102, causing display 102 to activate the “New Assignment” virtual lamp on the display of FIG. 6. The driver of tow truck 40 responds to the “New Assignment” virtual lamp being activated by pressing stylus 108 against the virtual “New Assignment” bar on the display of FIG. 6. In response to stylus 108 being placed on the “New Assignment” bar, personal computer 100 is activated to supply display 102 with the screen of FIG. 6. With the screen of FIG. 6 on display 102 the driver of tow truck 40 reviews the information on the screen to determine the type of the assignment and the address or addresses where the vehicle to be retrieved is likely to be. The driver of tow truck 40 puts the assignment in order geographically with his other assignments. The driver of tow truck 40 does this with a sort function that personal computer 100 stores.

At the appropriate time, during operation 144, the driver of tow truck 40 begins the recovery process, indicated by operation 146. If the driver of tow truck 40 is unable to retrieve the vehicle (operation 148, FIG. 8B), he activates the virtual “Updates” bar on the screen of FIG. 6 by pressing stylus 108 against this bar. Activating the virtual “Updates” bar on the display of FIG. 6 causes computer 100 to advance to operation 150, to display an update text box on display 102. The driver of tow truck 40 activates keyboard 104 to indicate that he was unable to retrieve the vehicle and the place or places where and the time when the attempted retrieval occurred.

Upon completion of the keyboarding associated with operation 150, the tow truck driver stylus 108 on the e-mail address on the upper part of the screen of FIG. 6. This causes the updated information to be transmitted as an e-mail message back to central station 12 via the link from transceiver 110 to transceiver 86. Database server 72 responds to and stores the e-mail message containing the updated information which is read from the database server to display 80 when the manager of station 12 is reviewing updates. For a particular vehicle to be retrieved by the driver of tow truck 40, database server 72 keeps track of the number of updates transmitted by the driver of tow truck 40 to central station 12.

During operation 150 the tow truck driver also has the option to send an urgent e-mail message to another user of the system of FIG. 1, for example, the manager of central station 12. The urgent e-mail indicates the inability of the tow truck driver to retrieve the vehicle. The tow truck driver uses keyboard 104 to enter the name of the system user who is to receive the urgent message. Personal computer 100 stores the e-mail address of the system user who is to receive the urgent message and activates transceiver 110 to transmit the urgent message to the user and database server 72, FIG. 2. When database server 72 supplies the update screen to display 80, the update screen includes the names of all system users who have had urgent messages transmitted to them and which have not been answered.

The driver of tow truck 40 usually continues to work on a particular assignment until the vehicle is retrieved. If, however, the driver of tow truck 40 is unable to retrieve the vehicle after a predetermined number (such as five) attempts, database server 72 responds, during operation 152, to the number of updates it has accumulated for the particular vehicle and sends a message to the manager of station 12 or a clerk at station 12. During operation 154 database server 72 supplies the display of the manager or clerk at station 12 with the message that the driver has been unable to retrieve the vehicle. Then, during operation 156, the manager or clerk contacts the representative of the lien holder, in an attempt to obtain further instructions with regard to retrieval of the vehicle. Alternatively or cumulatively, the manager or clerk at station 12 causes investigations to be instigated from other information sources concerning the location of the vehicle.

If further information is obtained, the file for the particular vehicle is updated during operation 158 by the clerk or manager activating a keyboard associated with his/her personal computer. The updated information is entered into database server 72 and transmitted from central station transceiver 86 to tow truck transceiver 110. Personal computer 100 at tow truck 40 responds, during operation 142, to the updated information, to activate the virtual “Updates” lamp of the screen of FIG. 6. The driver of tow truck 40 responds to activation of the virtual “Updates” lamp by pressing stylus 108 against the virtual “Updates” bar on the screen of FIG. 6. In response to stylus 108 being pressed against the Virtual “Updates” bar, computer 100 is activated to cause display of the screen of FIG. 5, whereby the driver of tow truck 40 is apprised of the new update.

If no further information is developed as a result of operation 156, the manager of station 12 closes the account, i.e., order, or puts it on hold by activating the keyboard associated with his computer during operation 160. This information is transmitted from the computer of the manager of station 12 to database server 72 at station 12, where the information is stored. The close or hold account information is transmitted from database server 72 to computer 100 of tow truck 40, causing display 102 to display the screen of FIG. 6 for the associated vehicle. In addition, computer 100 causes activation of the virtual “HOLD” or “CLOSE” lamps on the screen of FIG. 6 for the account to be closed or put on hold. The driver of tow truck 40 presses stylus 108 against the bar associated with the activated “HOLD” or “CLOSE” lamp, to cause removal of the order from the memory of computer 100 of the driver of tow truck 40.

The close or hold account information is also transmitted from database server 72 to an Invoice Processing Department at central station 12. The Invoice Processing Department prepares an invoice which is typically mailed to the lien holder. Database server 72 also sends an e-mail to the lien holder advising the lien holder that the order has been put on hold or closed. If the order is closed, all information about the order is sent by e-mail from database server 72 to a long-term electronic memory for orders which have been closed or completed. If the order is put on hold, database server 72 places the order into a hold queue, i.e., an electronic long-term memory. The order stays in the hold queue for a predetermined time. When the predetermined time has elapsed, the manager of station 12 is apprised of this fact by database server 72 transmitting a message to this effect to the computer of the manager of the station. The station manager then contacts the lien holder to determine what should be done in connection with the order.

If the driver of tow truck 40 is successful in recovering the vehicle, as indicated by operation 162, he presses stylus 108 against the virtual “CLOSE” bar of the screen illustrated in FIG. 6 (operation 164). Activation of the virtual “CLOSE” bar results in computer 100 activating display 102 to display a “yes” and “no” menu to the driver of tow truck 40 as to whether the vehicle, i.e., unit, was recovered. In response to the driver clicking on the resulting “yes” virtual bar on display 102, computer 100 transmits a signal to central station 12 indicating successful retrieval of the vehicle. During operation 164, the driver of tow truck 40 activates keyboard 104 to complete certain basic aspects of his report by indicating, for example, the date and time of recovery, the police department having jurisdiction over the repossession, the location where the vehicle was found and any other necessary information, such as difficulties the tow truck driver may have had with the debtor.

In response to the driver clicking on the “yes” virtual bar on display 102, computer 100, during operation 166, activates the virtual lamp associated with the “Cond. Reports” (i.e. condition report) bar. The driver of tow truck 40 presses stylus 108 against the “Cond. Reports” bar, causing computer 100 to supply display 102 with a menu containing parts of an automotive vehicle or a boat, as applicable, that might be damaged. The tow truck driver presses stylus 108 against the menu items associated with damaged parts of the vehicle or boat to cause this information to be stored in the memory of computer 100. The memory of computer 100 supplies this information and the information compiled during operation 164 to transceiver 110 which relays it back to central station 12 for storage in the memory of database server 72 in response to the driver of tow truck 40 again pressing stylus 108 against the “Cond. Reports” bar. The memory of database server 72 stores this information for future transmission to the lien holder.

In response to the driver of tow truck 40 again pressing stylus 108 against the “Cond. Reports” bar, computer 100, during operation 166, activates display 102 to cause activation of the virtual lamp associated with the “Personal Prop” bar of the screen of FIG. 6. This causes computer 100 to activate display 102 to enable the driver of tow truck 40 to list any personal property in the vehicle that appears to be owned by the debtor, i.e., is not subject to the indebtedness associated with the repossession. The driver of tow truck 40 keyboards this information into computer 100 for display on display 102 and transmission to database server 72 at station 12 in a manner similar to that described in connection with supplying the “Cond. Reports” information to station 12. Station 12 transmits the information in the “Cond. Reports” and “Personal Prop” reports to the lien holder in an e-mail message via the Internet 18 at the time station 12 e-mails the lien holder that the order has been completed by repossessing the vehicle.

If the screen of FIG. 6 has no special instructions for where the vehicle is to be taken, the driver of tow truck 40, after preparing the vehicle for transport, brings the vehicle to an impoundment lot in the general vicinity of station 12, as indicated by operation 170, FIG. 8C. If the tow truck works out of satellite station 14 or 16, the driver of the tow truck brings the vehicle to an impoundment lot in the general vicinity of the satellite station from which he works. Alternatively, the screen of FIG. 6 may have special instructions with regard to where the vehicle is to be taken for example, to an impoundment lot of a specific auctioneer, as indicated by operation 172 FIG. 8D.

The driver of tow truck 40 completes the condition and personal property reports, as previously described in connection with the screen of FIG. 6, for the vehicles which are delivered directly to auction, as indicated by operation 172. The tow truck driver may complete these reports shortly after retrieving the vehicle or at the auction site. However, it has been found advantageous for these reports to be prepared by personnel at the lot of the repossession agency, for those vehicles which are transported to the impoundment lot of the repossession agency, as indicated by operation 174, FIG. 8C. After the driver of tow truck 40 brings the repossessed vehicle to the lot of the repossession agency he closes out the account by pressing stylus 108 against the virtual “CLOSE” bar of the screen of FIG. 6 (operation 176), if he has not already done so.

Then, during operation 178, the manager of the impoundment lot reviews the closed report which is transmitted to his personal computer by database server 72. The impoundment lot manager, during operation 178, uses his personal computer to prepare an invoice for the assignment, i.e., order, and sends the invoice as an e-mail to the Invoice Processing Department at central station 12. If the impoundment lot manager is located at satellite station 14 or 16, the e-mail containing the invoice is sent via the Internet 18 to the Invoice Processing Department at central station 12.

After operation 178, the manager of the impoundment lot completes the personal property report, as indicated by operation 174, and puts the personal property in a bag which is secured and tagged and sent to storage, as indicated by operation 180. The impoundment lot manager, during operation 182, prepares an auction delivery form by using his personal computer. The lot manager, during operation 184, reviews all of his data entries and sends a message to database server 72. The lot manager, if necessary, has keys cut for the vehicle (operation 186) based on the information the lien holder originally supplied to the repossession agency. After operation 184, the lot manager causes the condition and personal property reports to be transmitted to the lien holder, as indicated by operation 186, FIG. 8D. If the lien holder has provided the repossession agency with an e-mail address, the lot manager accesses database server 72 which sends the condition and personal property reports to the lien holder by e-mail via the Internet 18. If the repossession agency only has the fax telephone number of the lien holder, the lot manager accesses database server 72 to cause a printer at the facility of the lot manager to be activated to print the condition and personal property reports that the lot manager sends via a telephone facsimile line to the lien holder.

The manager of station 12, as part of his functions, accesses the database server from time to time to determine the vehicles which have been retrieved, i.e., the orders which have been closed. The station manager, after making a determination that a particular vehicle has been repossessed, attempts to contact the representative of the lien holder by telephone or by e-mail to advise the lien holder that the repossession has been completed (operation 188). If the manager of station 12 is not able to reach the representative of the lien holder and has no other instructions with regard to disposal of the repossessed vehicle, the station manager has the vehicle stored in a hold field of the impoundment lot, as implied by operation 190, which also includes using the personal computer of the impoundment lot manager to create an additional invoice for incurred storage fees in the hold field. After operation 188 or 190, as applicable, the manager station of 12 sends the previously prepared invoice e-mail message to the Invoice Processing Department, with appropriate modification for the storage indicated by operation 190.

The impoundment lot manager arranges to have the repossession agency either deliver the repossessed vehicle to the designated destination (operation 192), usually by driving the vehicle to an auction lot (operation 194), or have the vehicle picked up by a third party, such as a delivery agency or the debtor (operation 196). If delivery is to a third party, the impoundment lot manager waits for a release from the lien holder (operation 198), which can be transmitted to the lot manager by telephone voice communication, telephone fax communication or e-mail via the Internet 18. If the lot manager receives the release by telephone voice communication or telephone fax communication, the lot manager prepares a release form by keyboarding the release information into his personal computer, operation 200. If the lot manager receives a release by e-mail, the release is automatically transmitted to database server 72 which activates the computer of the lot manager, which in turn drives the display and a printer associated with the computer of the lot manager. The printer produces a paper release form which the debtor or other third party signs, as indicated by operations 202 and 204, respectively.

If the driver of tow truck 40 takes the repossessed vehicle directly to auction, as indicated by operation 172, the tow truck driver, during operation 206, completes the necessary forms associated with such a delivery by activating keyboard 104. In particular, the tow truck driver keyboards the name and location of the auction facility, as well as the time and date of delivery to the auction facility. Prior to delivering the repossessed vehicle directly to auction, the driver of tow truck 40 removes the personal property from the vehicle and puts it in a bag, as indicated by operation 180, FIG. 8C. After the repossessed vehicle has been delivered to auction, either by being driven, as indicated by operation 194, or being towed by the driver of tow truck 40, a representative of the auction facility activates keyboard 104 of the computer facility of tow truck 40 with a coded computer signature unique to that auction facility. Personal computer 100 and transceiver 110 of tow truck 40 immediately respond to the coded computer signature and transmit the signature via secured e-mail to central station 12. If the tow truck delivering the repossessed vehicle is associated with satellite station 14 or 16, such a tow truck wirelessly transmits the secured e-mail to its associated station which in turn relays it to central station 12 via the Internet 18. Database server 72 at central station 12 responds to the coded computer signature to close out the order and transmit a message to the Invoice Processing Department, which in turn prepares an invoice, as discussed previously.

While there has been described and illustrated a specific embodiment of the invention, it will be clear that variations in the details of the embodiment specifically illustrated and described may be made without departing from the true spirit and scope of the invention as defined in the appended claims. The invention is not limited in all of its aspects to repossession services. For example, principles of the invention can be employed in delivery and pickup of foodservice products, such as pizza. In addition, it is generally preferred for the communications via the Internet and the telephone network to be cryptographically encoded.

We claim:

1. A method of filling orders a supplier receives from a plurality of customers, each order including information about an article associated with the order, the articles of different orders being susceptible of having different characteristics and different locations, the method comprising: the supplier responding to the transmitted orders by preparing a first message associated with each order, the first message including information about the characteristic of the article in connection with the order; electronically transmitting the first message to a field unit; the field unit including a transceiver coupled with a computer and a display coupled to be driven by the computer, the field unit being associated with an associate of the supplier who is assigned to perform the order; the electronic transmitting step including wireless reception of the first message by the transceiver of the field unit to cause the transceiver of the field unit to couple the first message to the computer of the field unit; the computer responding to the first message to cause the display to display information about the character of the article associated with the order, the computer also causing the display to display information about a location in connection with the article; the associate responding to the display by: (a) going to the displayed location and (b) executing the order in connection with the article; the associate supplying the computer with an input indicative of the success of its efforts in connection with the article at the displayed location; the computer responding to the input supplied to it by the associate by preparing a second message commensurate with the input the associate supplies to the computer; coupling the second message from the computer to the transceiver; the transceiver responding to the second message to transmit the second message to the supplier by a communication link including wireless transmission of the second message from the transceiver; the supplier responding to the second message by storing an indication that the order was successfully processed if the second message so indicates.

2. The method of claim 1 wherein the plural customers transmit orders to the supplier in different formats and the supplier causes all the first messages to have the same format.

3. The method of claim 1 wherein the supplier includes a computer arrangement which: (a) puts the different orders in the different formats into the first messages which have the same format, and (b) prepares a third message indicating the associate successfully processed the order.

4. The method of claim 3 wherein at least some of the different orders are transmitted by facsimile to the supplier, the computer arrangement putting the different orders in the different formats into orders having the same format, and forming the first messages by responding to the orders having the same format.

5. The method of claim 1 wherein the first message includes a location associated with the order and the computer responds to the first message by causing the display to display the location included in the first message, the associates being drivers who go to the displayed location by driving automotive vehicles to the displayed location.

6. The method of claim 1 wherein the communication link from the supplier to the field unit and the communication link from the field unit to the supplier include the Internet.

7. The method of claim 1 wherein the supplier transmits to the field unit plural messages concerning a plurality of orders at different locations, the computer responding to the plural messages to cause the display to simultaneously display general information about the plurality of orders, the associate responding to the displayed general information to select one of the plurality of orders, the computer responding to the selection by the associate to cause the display to display detailed information about the selected order.

8. The method of claim 1 wherein the supplier includes a computer arrangement which keeps track of the status of the orders, a customer determining the status of its order by accessing the computer arrangement via a communication link between the customer and the computer arrangement.

9. The method of claim 8 wherein the communication link between the customer and the computer arrangement includes the Internet, the customer accessing the computer arrangement by transmitting to the computer arrangement via the Internet a password associated with the customer, the computer arrangement providing the customer with the status of its order via the Internet only in response to the computer arrangement determining that the transmitted password is associated with the customer.

10. The method of claim 9 wherein the supplier includes a main station and at least one satellite station, each of the stations receiving orders from customers in proximity to that station and wirelessly transmitting the first messages to field units in proximity to that station and wirelessly receiving the second messages from field units in proximity to that station; the at least one satellite station (a) transmitting to the main station via the Internet the second messages it receives from field units, and (b) receiving from the main station via the Internet the first messages which it transmits to field units in proximity to that satellite station.

11. The method of claim 10 wherein the main station responds to orders communicated by all customers of the supplier by forming the first messages and assigning the orders to the different stations of the supplier.

12. The method of claim 8 wherein the customer accesses the computer arrangement by transmitting to the computer arrangement via a communication link a password associated with the customer, the computer arrangement providing the customer with the status of its order via a communication link only in response to the computer arrangement determining that the transmitted password is associated with the customer.

13. The method of claim 1 wherein the supplier includes a main station and at least one satellite station, each of the stations wirelessly transmitting the first messages to field units in proximity to that station and wirelessly receiving the second messages from field units in proximity to that station; the at least one satellite station (a) transmitting to the main station via the Internet the second messages it receives from field units, and (b) receiving from the main station via the Internet the first messages which it transmits to field units in proximity to that satellite station.

14. The method of claim 13 wherein the main station responds to orders communicated by all customers of the supplier by forming the first messages and assigning the orders to the different stations of the supplier.

15. A system for filling orders a supplier receives from a plurality of customers, each order including information about an article associated with the order, the articles of different orders being susceptible of having different characteristics and different locations, the system comprising a supplier computer arrangement for preparing a first message associated with each order, the first message including information about the characteristic of the article in connection with the order; a communication link coupled with the computer arrangement for transmitting the first message to a field unit; the field unit including a transceiver coupled with a computer and a display coupled to be driven by the computer, the field unit being an automotive vehicle in a fleet of automotive vehicles and being associated with an associate of the supplier who is assigned to perform the order; the communication link including a wireless portion for enabling the first message to be received by the transceiver of the field unit, the transceiver of the field unit and the computer of the field unit being adapted to be coupled together for causing the first message to be coupled from the transceiver to the computer, the computer being arranged to respond to the first message for causing the display to display information about the character of the article associated with the order, the computer being arranged for causing the display to display information about a location in connection with the article; the computer being arranged for responding to an input of the associate indicative of the success of its efforts in connection with the article at the displayed location; the computer being arranged to respond to the input supplied to it by the associate for preparing a second message commensurate with the input the associate supplies to the computer; the computer being coupled with the transceiver for coupling the second message from the computer to the transceiver; the transceiver being arranged to be responsive to the second message for transmitting the second message to the supplier computer by a communication link including wireless transmission of the second message from the transceiver; the supplier computer arrangement being arranged to respond to the second message and including a storage arrangement for storing an indication that the order was successfully processed.

16. The system of claim 15 wherein the plural customers transmit orders to the supplier in different formats and the computer arrangement is arranged for causing all the first messages to have the same format.

17. The system of claim 16 wherein the computer arrangement is arranged for preparing a third message indicating the associate successfully processed the order.

18. The system of claim 17 wherein at least some of the different orders are adapted to be transmitted by facsimile to the supplier, the computer arrangement being arranged for putting the different orders in the different formats into orders having the same format responsive to the orders having the same format for deriving the first messages.

19. The system of claim 15 wherein the first message includes a location associated with the order and the computer is arranged to respond to the first message by causing the display to display the location included in the first message.

20. The system of claim 15 wherein the communication link from the supplier to the field unit and the communication link from the field unit to the supplier includes the Internet.

21. The system of claim 15 wherein the supplier station is arranged to transmit to the field station plural messages concerning a plurality of orders at different locations, the computer being arranged to respond to the plural messages to cause the display to simultaneously display general information about the plurality of orders, the associate responding to the displayed general information to select one of the plurality of orders, the computer being arranged to respond to the selection by the associate to cause the display to display detailed information about the selected order.

22. The system of claim 15 wherein the computer arrangement is arranged for keeping track of the status of the orders, a communication link between the customer and the computer arrangement for enabling a customer to determine the status of its order by accessing the computer arrangement.

23. The system of claim 22 wherein the communication link between the customer and the computer arrangement includes the Internet, the computer arrangement being adapted to be responsive to the customer accessing the computer arrangement by transmitting to the computer arrangement via the Internet a password associated with the customer, the computer arrangement being arranged to provide the customer with the status of its order via the Internet only in response to the computer arrangement determining that the transmitted password is associated with the customer.

24. The method of claim 22 wherein the customer can access the computer arrangement by transmitting to the computer arrangement via the communication link a password associated with the customer, the computer arrangement being arranged to provide the customer with the status of its order via the communication link only in response to the computer arrangement determining that the transmitted password is associated with the customer.

25. The system of claim 15 wherein the supplier includes a main station and at least one satellite station, each of the stations being arranged for (a) wirelessly transmitting the first messages to field units in proximity to that station and (b) wirelessly receiving the second messages from field units in proximity to that station; the at least one satellite station being arranged for (a) transmitting to the main station via the Internet the second messages it receives from field units, (b) receiving from the main station via the Internet the first messages, and (c) wirelessly transmitting to field units in proximity to that satellite station the first messages.

26. The system of claim 25 wherein the main station is arranged for (a) responding to all orders communicated by customers of the supplier by forming the first messages and (b) assigning the orders to the different stations of the supplier and to the different associates.

27. A method of repossessing articles in response to orders from a plurality of lien holders holding liens on different personal property articles to be repossessed, each of the orders including information about the identity of the article to be repossessed in connection with the order, comprising transmitting the orders to a repossession agency, the repossession agency responding to the transmitted orders by preparing a first message associated with each order, the first message including information about the identity of the article to be repossessed in connection with the order; transmitting the first message to a mobile field unit; the field unit including a transceiver coupled with a computer and a display coupled to be driven by the computer, the field unit being associated with an associate of the agency who will attempt to repossess the article; the electronic transmitting step including wireless reception of the first message by the transceiver of the field unit to cause the transceiver of the field unit to couple the first message to the computer of the field unit; the computer responding to the first message to cause the display to display information about the identity of the article to be repossessed in connection with the order, the computer also causing the display to display information about the likely location of the article; the associate responding to the display by: (a) going to the displayed location, (b) ascertaining whether the article is at the location, and (c) attempting to repossess the article if the article is at the location; the associate supplying the computer with an input indicative of the success of its repossession efforts at the displayed location; the computer responding to the input supplied to it by the associate by preparing a second message commensurate with the input the associate supplies to the computer; coupling the second message from the computer to the transceiver; the transceiver responding to the second message by transmitting the second message to the agency by a communication link including wireless transmission of the second message from the transceiver; the agency responding to the second message by communicating to the lien holder that the article was successfully repossessed if the second message indicates the associate successfully repossessed the article.

28. The method of claim 27 wherein the plural lien holders transmit orders to the repossession agency in different formats and the agency causes all the first messages to have the same format.

29. The method of claim 28 wherein the agency includes a computer arrangement which: (a) puts the different orders in the different formats into the first messages which have the same format, and (b) prepares a third message including the indication of the second message if the second message indicates the associate successfully repossessed the article.

30. The method of claim 29 wherein at least some of the different orders are transmitted by facsimile to the agency, the computer arrangement putting the different orders in the different formats into orders having the same format, and forming the first messages by responding to the orders having the same format.

31. The method of claim 27 wherein the articles of personal property are automotive vehicles or trailer mounted boats and the associates are tow truck drivers who go to the displayed location by driving tow trucks for the automotive vehicles or trailer mounted boats to the displayed location.

32. The method of claim 31 wherein the first message includes a likely location of the automotive vehicle or trailer mounted boat to be repossessed and the computer responds to the likely location in the first message by causing the display to display the likely location.

33. The method of claim 32 wherein the automotive vehicle or trailer mounted boat includes a GPS transceiver, the agency: (a) tracking the location of the automotive vehicle or trailer mounted boat in response to signals associated with the GPS transceiver on the automotive vehicle or trailer mounted boat, and (b) including the tracked location in the first message; the displayed location being the tracked location.

34. The method of claim 31 wherein the automotive vehicle or trailer mounted boat includes a GPS transceiver, tracking the location of the automotive vehicle or trailer mounted boat in response to signals associated with the GPS transceiver on the automotive vehicle or trailer mounted boat, and relaying the tracked location to the computer, the displayed location being the tracked location as relayed to the computer.

35. The method of claim 27 wherein the communication link from the agency to the field unit and the communication link from the field unit to the agency includes the Internet.

36. The method of claim 27 wherein the agency transmits to the field unit plural messages concerning a plurality of articles to be repossessed, the computer responding to the plural messages to cause the display to simultaneously display general information about the plurality of articles to be repossessed, the associate responding to the displayed general information to select one of the plurality of articles, the computer responding to the selection by the associate to cause the display to display detailed information about the selected article.

37. The method of claim 27 wherein the agency includes a computer arrangement which keeps track of the status of the orders, a lien holder determining the status of its order by accessing the computer arrangement via a communication link between the lien holder and the computer arrangement.

38. The method of claim 37 wherein the communication link between the lien holder and the computer arrangement includes the Internet, the lien holder accessing the computer arrangement by transmitting to the computer arrangement via the Internet a password associated with the lien holder, the computer arrangement providing the lien holder with the status of its order via the Internet only in response to the computer arrangement determining that the transmitted password is associated with the lien holder.

39. The method of claim 37 wherein the lien holder accesses the computer arrangement by transmitting to the computer arrangement via a communication link a password associated with the lien holder, the computer arrangement providing the lien holder with the status of its order via a communication link only in response to the computer arrangement determining that the transmitted password is associated with the lien holder.

40. The method of claim 27 wherein the agency includes a main station and at least one satellite station, each of the stations wirelessly transmitting the first messages to field units in proximity to that station and wirelessly receiving the second messages from field units in proximity to that station; the at least one satellite station (a) transmitting to the main station via the Internet the second messages it receives from field units, and (b) receiving from the main station via the Internet the first messages which it transmits to field units in proximity to that satellite station.

41. The method of claim 40 wherein the main station responds to all orders communicated by lien holders to the agency by forming the first messages and assigning the orders to the different stations of the agency.

42. A system for repossessing personal property articles in response to orders from a plurality of lien holders holding liens on different articles to be repossessed, each of the orders including information about the identity of the article to be repossessed in connection with the order, the system comprising a computer arrangement connected to be responsive to inputs indicative of information in the orders, the computer arrangement being arranged for preparing a first message associated with each order, the first message for each order including information about the identity of the article to be repossessed in connection with the order; a communication link for transmitting the first messages from the computer arrangement to a mobile field unit; the field unit including a transceiver coupled with a computer and a display coupled to be driven by the computer, the field unit being associated with an associate of the agency who will attempt to repossess the article; the communication link including a wireless portion for transmitting the first message to the transceiver, the transceiver and the computer being coupled together for causing the first message to be coupled from the transceiver to the computer, the computer being arranged to respond to the first message for causing the display to display information about the identity of the article to be repossessed in connection with the order, the computer being coupled with the display for causing the display to display information about the likely location of the article; the computer being arranged to respond to an input by the associate indicative of whether or not the associate was successful in repossessing the article; the computer being arranged to respond to the inputs applied to it by the associate for preparing a second message commensurate with the input the associate supplies to the computer; the computer being arranged to be coupled with the transceiver for coupling the second message from the computer to the transceiver; the transceiver being coupled with the computer for responding to the second message to transmit the second message to the agency by a communication link including a wireless portion for the second message from the transceiver to the computer arrangement; the computer arrangement being arranged for communicating to the lien holder that the article was successfully repossessed if the second message indicates the associate successfully repossessed the article.

43. The system of claim 42 wherein the plural lien holders can transmit orders to the computer arrangement in different formats and the computer arrangement is arranged for causing all the first messages to have the same format.

44. The system of claim 43 wherein the computer arrangement is arranged for: (a) putting the different orders in different formats into the first messages which have the same format and (b) preparing a third message including the indication of the second message if the second message indicates the associate successfully repossessed the article.

45. The system of claim 44 wherein at least some of the different orders are transmitted by facsimile to the computer arrangement, the computer arrangement being arranged for putting the different orders in different formats into the first messages having the same format.

46. The system of claim 42 wherein the articles of personal property are automotive vehicles or trailer mounted boats and the field units are in tow trucks for the automotive vehicles or trailer mounted boats.

47. The system of claim 46 wherein the first message includes a likely location of the automotive vehicle or trailer mounted boat to be repossessed and the computer of the field unit is arranged for causing the display to display the likely location in response to the likely location included in the first message.

48. The system of claim 47 wherein the automotive vehicle or trailer mounted boat includes a GPS transceiver, the computer arrangement being coupled with the Global Positioning System for: (a) tracking the location of the automotive vehicle or trailer mounted boat in response to signals associated with the GPS transceiver on the automotive vehicle or trailer mounted boat and (b) including the tracked location in the first message.

49. The system of claim 46 wherein the automotive vehicle or trailer mounted boat includes a GPS transceiver, the GPS system thereby being capable of tracking the location of the automotive vehicle or trailer mounted boat in response to signals associated with the GPS receiver on the automotive vehicle or trailer mounted boat and the arrangement for relaying, the repossessing system being arranged to be responsive to the GPS transceiver on the automotive vehicle or trailer mounted boat for causing the computer to provide the display with the location of the automotive vehicle or trailer mounted boat based on the GPS system tracking of the automotive vehicle or boat by way of the GPS transceiver included in the automotive vehicle or trailer mounted boat.

50. The system of claim 42 wherein the communication link from the computer arrangement to the field unit and the communication link from the field unit to the computer arrangement includes the Internet.

51. The system of claim 42 wherein the computer arrangement is arranged for causing transmission to the field unit of plural messages concerning a plurality of articles to be repossessed, the field unit computer being arranged to be responsive to the plural messages for causing the display to simultaneously display general information about the plurality of articles to be repossessed, the associate responding to the display general information by deriving an input associated with one of the plurality of articles, the computer being arranged to be responsive to the input associated with the one article for causing the display to display detailed information about the selected article.

52. The system of claim 42 wherein the computer arrangement is arranged for keeping track of the status of the orders, a communication link between the lien holder and the communication arrangement for enabling the lien holder to access the computer arrangement to determine the status of its order.

53. The system of claim 52 wherein the communication link between the lien holder and the computer arrangement includes the Internet, the lien holder accessing the computer arrangement by transmitting to the computer arrangement via the Internet a password associated with the lien holder, the computer arrangement being arranged for providing the lien holder with the status of its order via the Internet only in response to the computer arrangement determining that the transmitted password is associated with the lien holder.

54. The system of claim 52 wherein the lien holder accesses the server by transmitting to the computer arrangement via a communication link a password associated with the lien holder, the computer arrangement being arranged for providing the lien holder with the status of its order via the communication link only in response to the computer arrangement determining that the transmitted password is associated with the lien holder.

55. The system of claim 42 wherein the agency includes a main station and at least one satellite station, each of the stations being arranged for (a) wirelessly transmitting the first messages to field units in proximity to that station and (b) wirelessly receiving the second messages from field units in proximity to that station; the at least one satellite station being arranged for (a) transmitting to the main station via the Internet the second messages it receives from field units, (b) receiving from the main station via the Internet the first messages, and (c) transmitting to field units in proximity to that satellite station the received first messages.

56. The system of claim 55 wherein the main station is arranged for (a) responding to all orders communicated by lien holders by forming the first messages and (b) assigning the orders to the different stations.
